(19) United States
(12) Patent Application Publication
(10) Pub. No.: US 2016/0055122 A1
(43) Pub. Date: Feb. 25, 2016

(54) DESIGN AND ANALYSIS OF SILICON PHOTONICS ARRAY WAVE GUIDES

(71) Applicant: Mentor Graphics Corporation, Wilsonville, OR (US)

(72) Inventor: Sandeep Koranne, West Linn, OR (US)

(73) Assignee: MENTOR GRAPHICS CORPORATION, Wilsonville, OR (US)

(21) Appl. No.: 14/832,716

(22) Filed: Aug. 21, 2015

Related U.S. Application Data
(60) Provisional application No. 62/040,950, filed on Aug. 22, 2014.

(51) Int. Cl. G06F 17/10; G06F 17/50

(52) U.S. Cl. CPC G06F 17/10; G06F 17/50

(57) ABSTRACT

Methods and apparatus are disclosed for symbolic methods using algebraic geometry (e.g., based on a Gröbner basis of tangent space polynomials of parametric curves). For example, the design, optimization and verification of silicon photonic wave guides using parametric polynomials and/or Gröbner basis functions can be used to perform envelope generation, rectification, manufacturability, singularity detection, reticle and etch processing model generation, tapering loss minimization, and bend loss minimization. In one example, a method of analyzing a layout to be manufactured using a photolithographic process includes producing an envelope of a curve representing a layout object based at least in part on a Gröbner basis and performing one or more analysis operations for the envelope to perform verification and manufacturability checks.

### CROSS-REFERENCE TO RELATED APPLICATION

This application claims the benefit of U.S. Provisional Application No. 62/040,950, filed Aug. 22, 2014, which application is incorporated herein by reference in its entirety.

### SUMMARY

Apparatus and methods are disclosed for the design, analysis, testing, and manufacture of layout including curved objects, including silicon photonic array wave guides, micro-electronic mechanical systems (MEMS) and/or a micro-fluidics VLSI layouts. The layouts can be manufacturing using, for example, photolithographic processes including the use of patterned masks and/or reticles. In some examples, electronic beams are employed to perform layout patterning.

In some examples of the disclosed technology, a method of analyzing a layout to be manufactured using a photolithographic process includes producing an envelope of a curve based at least in part on a Gröbner basis, the curve representing an object in the layout, and performing one or more analysis operations for the envelope.

In some examples, the analysis operations include at least one or more of the following verification checks: a dimensional check, a spacing check, a width check, and/or an enclosure check.

In some examples, the analysis operations include at least one or more of the following operations: singularity detection, manufacturability checking, and/or bias application.

In some examples, the analysis operations include dimensional checks using quantifier elimination.

In some examples, the analysis operations include filtering data representing the layout using rectilinear bounding boxes representing the extent of a plurality of objects in the layout.

In some examples of the disclosed technology, a curved layout is represented using a system of one or more equations. In some examples, the layout object comprises optical interconnect. In some examples, the layout comprises one or more silicon photonic devices. In some examples, the layout comprises curves for a micro-electronic mechanical system (MEMS) and/or a micro-fluidics VLSI layout. In some examples, the curve is a parametric curve or a Bezier curve. In some examples, the envelope is produced based at least in part using Buchberger's algorithm.

In some examples of the disclosed technology, a method further includes, based on the performing the analysis operations, storing the layout in a computer readable storage medium. In some examples of the disclosed technology, a method further includes, based on the performing the analysis operations, generating a file comprising instructions for a mask or reticle manufacturing tool. In some examples of the disclosed technology, a method further includes, based on the performing the analysis operations, manufacturing an integrated circuit. In some examples of the disclosed technology, a method further includes, based on the performing the analysis operations, generating one or more waivers for a design rule or manufacturability check. In some examples of the disclosed technology, a method further includes, based on the performing the analysis operations, modifying the layout object.

In some examples of the disclosed technology, one or more computer readable storage media store computer-readable instructions that when executed by a computer, cause the computer to perform any one of the disclosed methods.

This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures. Further, any trademarks used herein are the property of their respective owners.

### BRIEF DESCRIPTION OF THE DRAWINGS

FIG. 1 is a schematic of an exemplary array waveguide grating (AWG).

FIG. 2 illustrates an example tangent space formation of an envelope (formed by the circle as a secondary curve) around a primary curve (shown as solid line), constant bias application, and minimum width checking of curves, as can be used in certain examples of the disclosed technology.

FIGS. 3A-3B illustrate an example bend contour optimization for waveguides. In particular, FIG. 3A illustrates a circular bend and FIG. 3B illustrates an adiabatic bend, as can be used in certain examples of the disclosed technology.

FIGS. 4A-4B illustrate an example of parametric curves. In particular, FIG. 4A illustrates a parabola and FIG. 4B illustrates Bezier curve, as can be used in certain examples of the disclosed technology.

FIG. 5 illustrates an example piecewise linear approximation for rectification, as can be used in certain examples of the disclosed technology.

FIGS. 6A-6B depict a family of circles traveling on a line y=x and their corresponding envelope. In particular, FIG. 6A illustrates family of circles on line y=x, and FIG. 6B illustrates a tangent space, as can be used in certain examples of the disclosed technology.

FIG. 7 illustrates a singular curve y²=x²(1+x), as can be used in certain examples of the disclosed technology.

FIG. 8 depicts a Y-junction component, as can be used in certain examples of the disclosed technology

FIGS. 9A-9B illustrate dimensional check operators for layout verification, as can be performed in certain examples of the disclosed technology. In particular, FIG. 9A illustrates dimensional checks and FIG. 9B illustrates upper/lower envelopes and EXT(A, B) and ENC(A, B) check.

FIG. 10 depicts an inverse computation of a polynomial parameter range from a bounding box intersection, as can be used in certain examples of the disclosed technology.

FIG. 11 is a schematic representation of an exemplary photonic coupler circuit, as can be implemented in certain examples of the disclosed technology.

FIG. 12 depicts a hierarchical tree of an example photonic design, as can be used in certain examples of the disclosed technology.

FIG. 13 depicts rectilinear bounding boxes of an example photonic design, as can be used in certain examples of the disclosed technology.

FIG. 14 illustrates a mask layout generated from an algebraic representation according to the disclosed technology.

FIG. 15 is a flow chart outlining an exemplary method according to certain examples of the disclosed technology.

FIG. 16 is a diagram of a suitable computing environment in which certain disclosed methods and apparatus can be implemented.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “evaluate,” and “perform” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Some of the disclosed methods can be implemented as computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as computer-readable instructions executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technology

Although the demise of Moore's law has been predicted many times in the recent past, the emergence of silicon photonics has the potential to extend the lifetime of Moore's law significantly. Photonics has been in use for the past several decades in the field of communications, in the form of optical interconnect, which has many advantages over conventional copper interconnect, as even at small distances, copper becomes bandwidth limited due to skin-effect and dielectric losses, and is rarely used at 10 GHz and above frequencies. Recently photonic device integration with on-chip silicon has resulted in the genesis of the field of silicon photonics and photonic integrated circuits.

However, before silicon photonics became ubiquitous, problems of silicon-based light emitters/lasers, and more importantly, low-cost manufacturing had to be resolved. Light emission in silicon is a challenge, as bulk crystalline silicon is an indirect bandgap material. This implies that the electron to photon conversion phenomenon is a second order effect in quantum mechanics, and correspondingly has a low probability of occurrence. This limitation can be overcome by using the principle of quantum confinement, and Raman scattering. Similarly, using the basic concepts of field-effect, researchers have created photonic structures where the refractive index of the silicon material changes with applied voltage, which in turn induces a phase shift in the optical path through the device, enabling the construction of photonic devices in CMOS very large scale integration (VLSI).

The other fundamental problem holding back silicon photonics was the cost of manufacturing integrated silicon photonic devices. Recently, compact integration of photonic circuits using silicon-on-insulator (SOI) fabrication processes (e.g., in complementary metal oxide semiconductor (CMOS) process techniques) has been performed. Utilizing CMOS processing for the generation, routing, and processing of light waves, silicon photonics has finally brought the full power of photonics to VLSI.

However, along with these benefits, significant challenges in computer aided design (CAD) and electronic design automation (EDA) of silicon photonics have also arisen. Silicon photonics structures (especially photonic index wires) are curvilinear, and thus present unique challenges to the computational geometry software implemented for VLSI layout design and analysis, the vast majority of existing software is designed and optimized for rectilinear data, omnipresent in conventional VLSI layouts. Current electronic design automation VLSI CAD systems are designed and optimized for Manhattan structures, and thus have difficulty operating on curvilinear structures of photonic ICs. Even planar straight line nonrectilinear polygons require specialized treatment, and computational geometry books always caution about the use of finite precision arithmetic when implementing standardized geometrical algorithms which assume infinite precision. One issue is the representation and maintenance of topological consistencies at intersection points of multiple nonrectilinear segments. Techniques such as snap-rounding and interval arithmetic are used, but these have implementation and run-time challenges. In VLSI CAD, correct and efficient handling of nonrectilinear data is still an ongoing topic for active research.

When curvilinear segments are added to the design, the situation becomes even more complex. The presence of non-Manhattan structures can cause problems of missed or confusing design rule checking (DRC) errors and the introduction of thousands of false errors, which have to be inspected manually. Other techniques include upfront scaling of the design by a factor of 10000× such that snapping and rounding issues are alleviated. However, conventional VLSI CAD tools often snap curvilinear shapes to grid lines during layout, which renders this technique useless for conjoint photonic structures which are formed by abutment of primitive shapes, as the intersection of these shapes may not lie on a grid point. Moreover, mask discretization has a very large impact on the performance characteristic of the waveguide. As the mask writing machines have limited precision, the upfront scaling of 10000× may be convenient for the design and verification of the drawn layout, but is akin to pushing the can down the road to the mask shop, where there is little or no control on the design layout. Researchers have reported either large degradation in waveguide performance, or unacceptably large mask processing runtime with nonoptimized curvilinear photonic structures. Existing computational geometry libraries may support curves for the construction of arrangements and 2-D intersection of curves, but tool performance is not comparable to standard scanline implementations. Further, silicon photonic layouts, especially waveguides have properties which are not present in conventional CMOS structures. For example, two (or more) waveguide layout structures may overlap, but with the correct wavelength design, do not logically intersect. Thus, the use of conventional layout verification software combines single layer intersecting polygons, presenting a challenge for layout versus schematic verification.

Containment and propagation of light in a dielectric slab waveguide is very sensitive to line edge roughness, and thus all aspects of VLSI manufacturing, such as lithography, optical proximity correction, mask data preparation, etch and resist models are desirably carefully optimized. To optimize chip area, design of waveguide curves of small curvature is required, but this increases bend loss. An accurate model, and optimization method is required, which allows the designer to perform tradeoffs between chip area and power transfer loss. Moreover, certain types of curves are more amenable to this tradeoff, and thus play an important role in parametric curve design for wave guides. The interface between the multimode fiber optic connection from off-chip systems to the single mode photonic index wire suffers from junction loss, and thus, accurate modeling of the vector equations to design diffraction gratings is required.

The disclosed technologies include methods based on Gröbner basis of tangent space polynomials of parametric curves. Disclosed technologies include design, optimization and layout verification of silicon photonic waveguides, using parametric polynomials, and demonstrate the powerful method of Gröbner basis functions to solve complex problems such as envelope generation, rectification, biasing, manufacturability verification, reticle, and etch processing models, tapering challenges and bend loss minimization. Methods presented in this disclosure are also applicable to the design and analysis of MEMS VLSI designs and micro-fluidics layouts, as these layouts also have non-Manhattan and curvilinear structures.

In some examples of the disclosed technology, algebraic geometry (e.g., Gröbner basis methods) can be used to solve many of the design and analysis problems of array waveguides. In some examples of the disclosed technology, the design of array waveguide layouts using parametric and algebraic representations (similar to the ones used in other photonics systems such as visual automated nanophotonic design and layout (VANDAL), IPKISS, and OIL) are employed, as opposed to vector or raster representations. Using symbolic representations allows for the use of computerized analysis. Moreover, it also allows for retargeting of waveguide designs to different technology process (such as a manufacturing node reduction from 20 to 16 nm).

Silicon photonics with particular emphasis on the design of waveguides, the silicon photonic structure, are disclosed with reference to the illustrated techniques. Mathematical techniques of affine varieties, polynomials, Gröbner basis and implicitization as can be applied to design and analysis of silicon photonics are disclosed. In some instances, the descriptions are based on assumed isotropic and nonmagnetic materials, although the disclosed techniques can be readily extended to other types of materials.

### III. Silicon Photonics

Two predominant structures in integrated silicon photonics are photonic index wires, and photonic band gap (PBG) waveguides. Waveguides function by guiding light through total internal reflection based on the contrast in the refractive index of the waveguide core and the surrounding cladding. As described, semiconductor to air, or semiconductor to silica contrasts are obtainable for waveguides smaller than 500 nm. The refractive index of SOI semiconductor is n=3.45, silica is n=1.45, and that of air is n=1.0.

Photonic index wires include photonic waveguides that have a width of 300-400 nm, and light is confined and guided using total internal reflection. Performance of photonic index wires is limited by line-edge roughness, and thus accurate modeling of silicon processing steps and their optimization are crucial to achieving good performance. PBG crystals are periodic structures which have high refractive index. They guide light on their line defect. Accurate manufacturing of photonic wires as well as PBG requires careful consideration of lithographic, resist models as well as mask manufacturing.

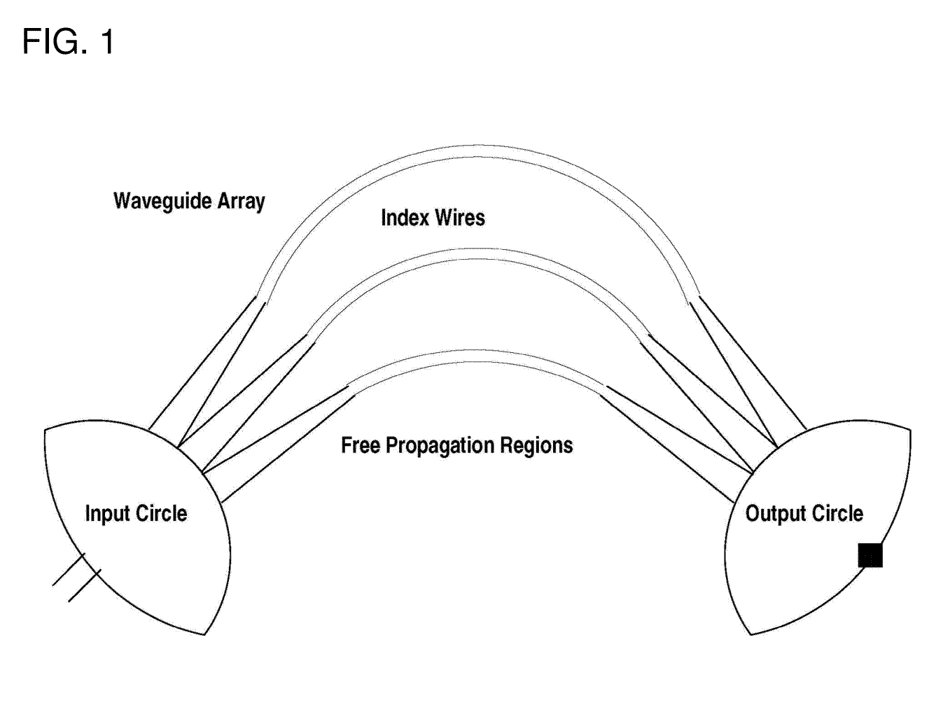

Using array wave guides along with grating couplers and diffraction systems, a wide variety of processing elements have been designed. These include wavelength multiplexing and demultiplexing circuits, and N×N star couplers. Array waveguide gratings (AWG) are planar devices that are based on an array of waveguides with imaging and dispersive properties. A schematic of an AWG is shown in FIG. 1. The beam of light entering in the input circle propagates through the free propagation region and is no longer confined, thus it diverges. On arriving at the input aperture of the waveguide array it is coupled onto the waveguide and propagates through the individual waveguides to the output circle. The length of the array waveguide is carefully chosen such that the optical path difference ΔL is calculated as

$$Δ L = {m}_{{N}_{eff}}^{{λ}_{c}}$$

where ΔL denotes the optical path difference between adjacent waveguides, λ_{c} is the central wavelength, and N_{eff} is the effective index of the system. The optical path difference can be made an integer (m) multiple of the central wavelength. The input aperture can be analyzed as a confocal arrangement of two circles with a periodic array of radial waveguides. As each confocal circle contains the center of the other, they can be related by a Fourier transform. As shown in FIG. 1, the periodic array consists of tapered waveguides formed between two reference circles. The impulse response of this Fourier transformation, along with the optical path length difference, are important parameters of the AWG. Given the AWG as a building block complex photonic circuits such as wavelength division multiplexing (WDM) switches, routers, multiplexers, optical switches, couplers, add-drop switches, and many more can be constructed.

### IV. Example Applications of the Disclosed Technology

Consider the design of the waveguide array as shown in FIG. 1. Analysis and optimization of this structure includes applications to the following problems.

A. Envelope Creation and Singularity Detection

Although the waveguide curve can be specified in a computer as an ideal zero width line, its manufacture as a photonic waveguide of a specific width (e.g., 100 nm) in CMOS VLSI can use a representation in GDSII or open artwork system interchange standard (OASIS) formats. These formats, which have their genesis in the design and manufacture of conventional rectilinear CMOS devices, do not have special constructs for curved surfaces. OASIS, however, does have a double delta representation of polylines which can be used to create a piece-wise linear (PWL) approximation to the curve. OASIS also has a CIRCLE data-type, but it does not have an arc representation. Mathematically, the operation of converting a zero width curve to a finite width representation can be modeled as a tangent surface formulation, or equivalently as a Minkowski operation.

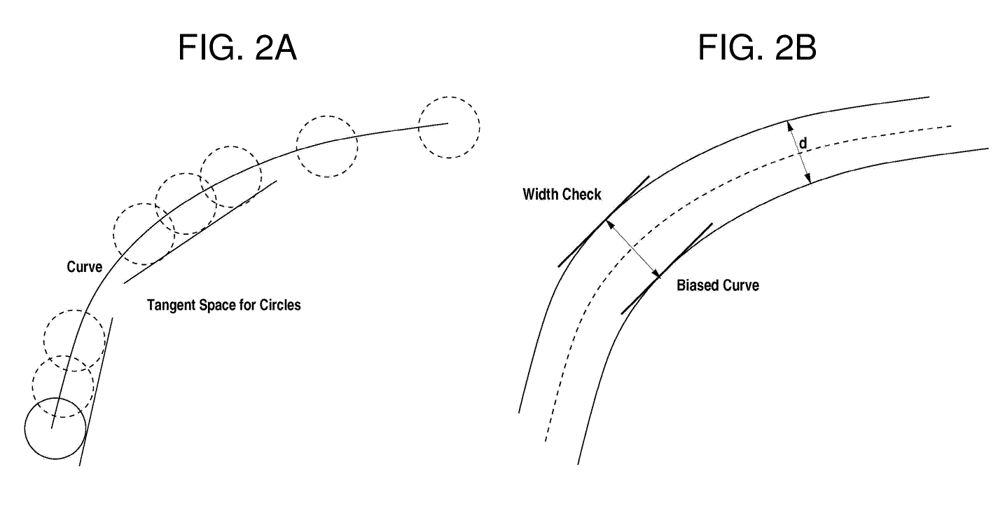

The conversion of the curve to its 2-D realization can be implemented as a tangent space surface conversion, as shown in FIG. 2(a). It should be noted that creation of a 2-D tangent surface can lead to the formation of singularities. The construction of the tangent surface (called the envelope) and the checking of singularities is discussed in further detail below

B. Manufacturability Checking

Given a computer representation of the waveguide array and the CMOS process in which it is to be manufactured, the geometrical realization is typically checked for manufacturability, a process known as design rule check (DRC). Since the layout of the waveguide array comprises of many curvilinear segments, this is a nontrivial task. The DRC dimensional checks can include, for example, spacing, minimum width and enclosure checks. An example of a minimum width DRC is shown in FIG. 2(b). Additional checks include mask manufacturing rule checks (MRC), such as resolution snapping. In some examples of the disclosed technology, a method represents waveguide curves using parameterized rational curves, and we use quantifier elimination (QE) to perform spacing, width, and various other checks on waveguide curves, as described in further detail below.

C. Process Modeling and Bias Optimization

Modeling of isolated waveguide wires can account for process- and geometry-dependent biases. A bias is a Minkowski-type addition (dilation) or subtraction used to compensate for the manufacturing process. An example is shown in FIG. 2(b). Accurate calculation of bias for curvilinear shapes is nontrivial, as maintaining topological consistency of the output is complicated by the creation of singularities. At the same time, structures such as rib-waveguides, require accurate overlay processing for manufacturing the raised rib. One suitable representation of waveguides is parametric in t as x=f(t), y=g(t), thus, if curve c₁(t)=(f₁(t), g₁(t)) is overlapped with curve c₂(t)=(f₂(t), g₂(t)), a parametric representation of c₁ ̂ c₂ can be directly computed. Disclosed methods of calculating offsets of parametric curves are presented below.

D. Mask Optimization

Different representations of the same curve in VLSI layout can cause large variations in the number of mask data preparation shots needed to image the shape of the curve onto the silicon wafer, which in turn can cause large performance degradation in the waveguide. Earlier mask writers used circular beams, but modem writers are trapezoid-based (an example of a variable-shape beam). Thus, careful optimization of the generated curve prior to a PWL output in GDSII or OASIS is recommended. With our proposed method of parametric representation, mask data preparation operations are simplified considerably, as the instantaneous curvature (at t) of the primary curve determines the trapezoid slopes completely, and the tangent lines of the envelope are exactly computed for every x(t), y(t) location in our method.

E. Optimization of Waveguides

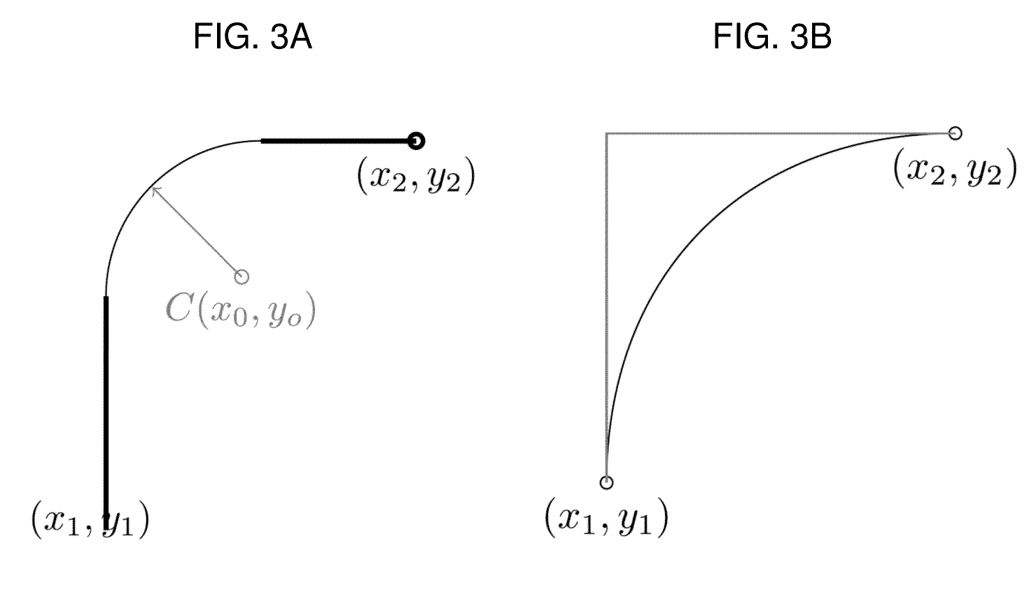

The shape of waveguide curve can be tuned using the disclosed technology to reduce detrimental effects such as bend loss and junction loss. Since waveguides and couplers are used for optical transport, they are often provided as primitive building blocks in photonics process design kits (PDK). Loss minimization for bends can be performed various techniques such as contour-optimized bends, optimal constant width bends, and adiabatic bends to alleviate the bend loss problem. An example of a circular bend of 90° is shown in FIG. 3(a), while an adiabatic bend of 90° is shown in FIG. 3. In both cases, the optical signal is transported from point (x₁, y₁) to (x₂, y₂).

The adiabatic bend shown in FIG. 3(b) is generated using a Bezier curve. Optimizations using Bezier curves are discussed further below. In the illustrated example, using an adiabatic bend for a 3 μm bend radius, reduced the bend loss from 0.037 to 0.009 dB. Other aspects of design optimization are curvature minimization, and the design of adiabatic tapers, diffraction gratings and optimization of wavelength independent fundamental modes.

### V. Mathematical Explanation of Aspects of the Disclosed Technology

Unless otherwise stated, we consider the field of complex numbers C as the underlying field for the discussion (however, the plots are drawn in the real field R for ease of explanation).

A monomial in x₁, x₂, . . . , xₙ is a product of the form

x₁^{α}^{₁}x₂^{α}^{₂} . . . xₙ^{α}^{ₙ}.

Thus, polynomials in n variables with coefficient in an arbitrary field k are finite linear combinations of monomials

f=Σcₖx₁^{α}^{₁}x₂^{α}^{₂} . . . xₙ_{ₙ}^{α}

where cₖ is a coefficient in field k.

A. Affine Varieties

Using the definition of polynomials, we can define affine varieties of polynomials f₁, f₂, . . . , fₛ as V

V(f₁, f₂, . . . , fₛ)⊂ kⁿ

is the set of all solutions to the system of s equations f₁(x₁, x₂, . . . , xₙ)=fₛ(x₁, x₂, . . . , xₙ)=0. As an example, the 2-D unit circle is the affine variety corresponding to

V(x²+y²−1)

since x²+y²=1 for the unit circle. In general, for any graph of a rational function, y=f(x), its corresponding affine variety is V(y−f(x)).

B. Parametric Curves

Since in our application domain, there are a relatively small number of variables, x and y are used for the variables in this particular example. We use t as an auxiliary variable for parametric curves. Consider the parametric curved defined as

x=2+t, y=8−t². (Eq. 3)

One eliminate t as x−2 and substituting for y, producing

y=−x²+4x+4. (Eq. 4)

The affine variety corresponding to this curve is given as

V(y+x²−4x−4).

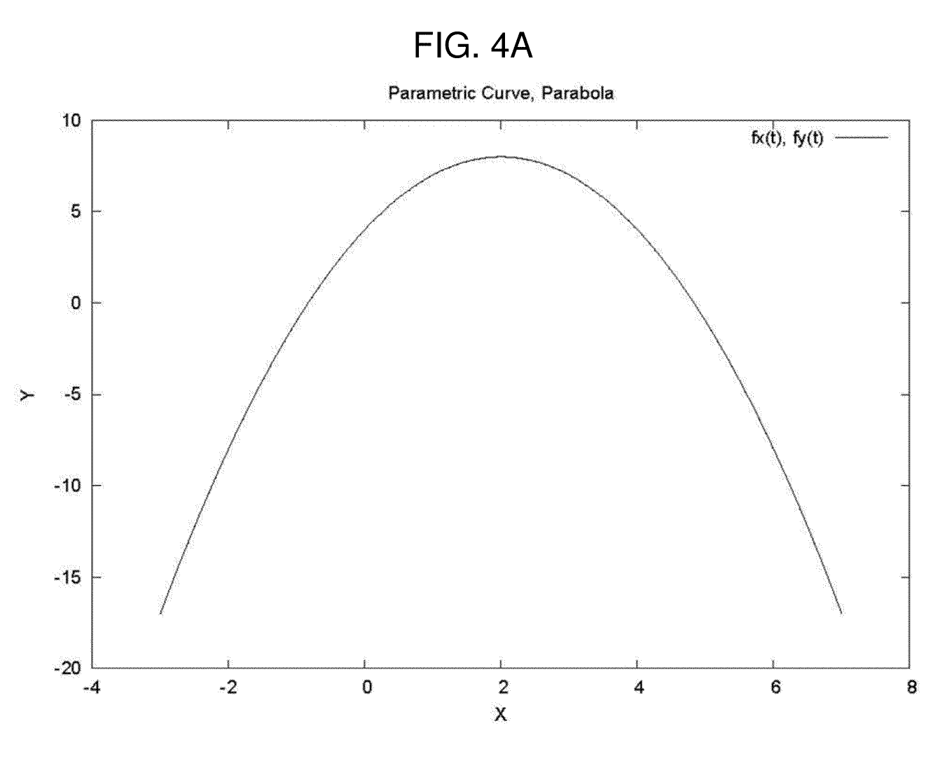

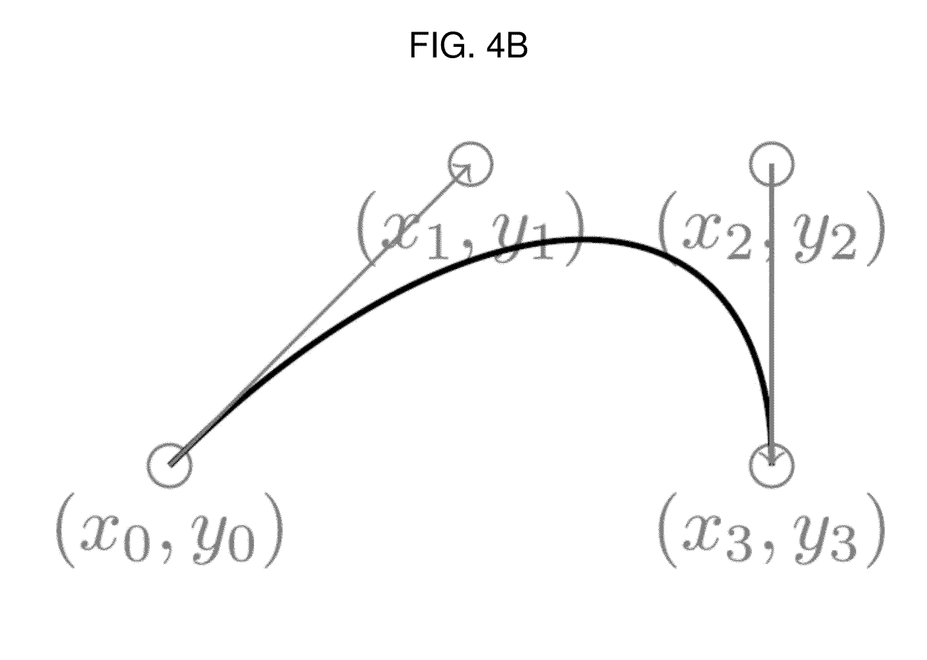

The corresponding curve itself is shown in FIG. 4(a).

C. Using Bezier Curves

Consider the parametric curve shown in FIG. 4(b). The curve is an example of a Bezier curve and can be parameterized as

x=(1−t)³x₀+3t(1−t)²x₁+3t²(1−t)x₂+t³x₃

y=(1−t)³y₀+3t(1−t)²y₁+3t²(1−t)y₂+t³y₃.

Many of the actual waveguides in current photonics chips can be modeled as the above parametric curves, or combinations thereof.

D. Implicitization

The nonparametric form of the curve is known as the implicit form. While the parametric form is useful for computer plotting, the implicit form can be used to answer point-on-curve queries. For example, given the curve of (Eq. 4), we would like to check if the point (−2, 0) lies on the curve. Given the parametric form, the following system of equations can be solved:

−2=2+t (Eq. 5)

0=8−t² (Eq. 6)

for t within the given range. However, given the implicit form

y=−x²+4x+4 (Eq. 7)

the values x=−2 can be applied and verified that y=−8≠0, thus the point (−2, 0), does not lie on the curve. The process of converting a parametric curve to its implicit form is called implicitization, and for rational curves, as used in photonic waveguides, implicitization can be performed efficiently.

E. Rectification

Since a primary function of a waveguide array is to introduce an optical path length difference ΔL between adjacent waveguides, the length of individual wires needs to be calculated and designed correctly. The small variations caused by CMOS manufacturing also need to be controlled tightly as line edge roughness can cause leakage of light, reducing the power transferred. Given a parametric curve denoting the curve of the waveguide, the calculation of its length is called rectification. For rational curves, the length is finite and can be calculated using a piecewise linear (PWL) approximation or calculus.

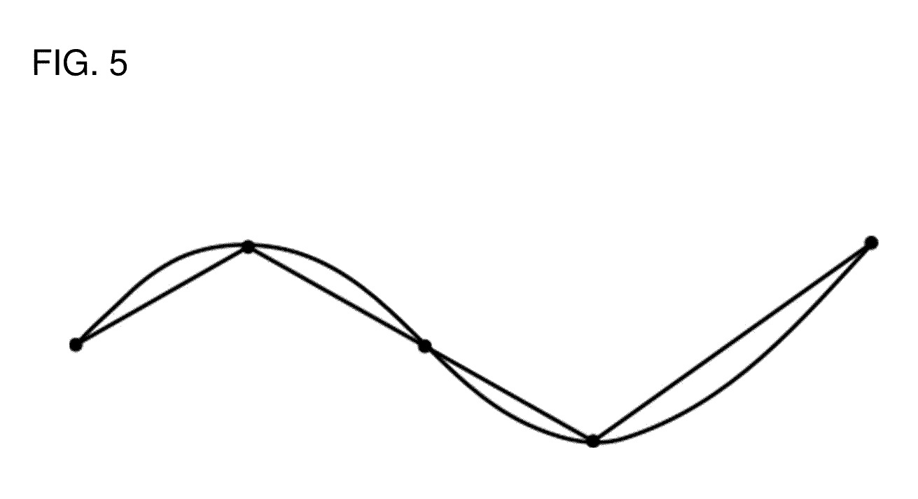

Using PWL, the curve is approximated by a sequence of straight line segments as shown in FIG. 5. The points for the segments are chosen on a uniform basis (e.g., based on an expected degree of the curve). The number of points may have to be increased if the curve intersects the segments. Given the sequence of points, the length is calculated using the Pythagoras theorem as Σᵢ\sqrt{Δxᵢ²+Δyᵢ²} where Δxᵢ is the difference in x coordinate, and Δyᵢ is the difference in y coordinate between adjacent points, respectively. As the number of segments approximating the curve increases, the PWL length approximates the true length closely.

An alternate method uses calculus. If y=f(x) represents the function, and f(x) as well as f(x), are continuous in the range [a,b] of interest, then the length of the curve y=f(x) between x=a and x=b is

s=∫ₐ^{b}\sqrt{1+[f′(x)]²} dx (Eq. 8)

if the curve is defined using a parameter t with x=fx(t), and y=fy(t) [as shown in (3)], then the length of the curve is

s=∫ₐ^{b}\sqrt{[fx′(t)]²+[fy′(t)]²} dt. (Eq. 9)

The length of the curve is an intrinsic measure, and is independent of the parameterization used. For the curve shown in FIG. 4(a) given by y=−x²+4x+4, dy/dx=−2x+4. The length of the parabola from X=[−2,2] can be calculated from (8)

s=∫₋₂²\sqrt{1+(4−2x)²}dx. (Eq. 10)

A numerical evaluation gives the length of the curve to be 16.818 units. The above example shows, that in general, calculating the arc length of curves is nontrivial. The calculus-based method can be used to calculate optimal waveguide bends with constant width. In practice, computing the length of a waveguide accurately is nontrivial. If the length is calculated as a half-perimeter (minus the width of both ends), then during the process of converting the curve to vector or raster formats, the length of the curve can be significantly perturbed with observed errors of 10% or more.

F. Ideals

If f₁, f₂, . . . , fₛ are polynomials in n variables and using the definition of affine variety, the ideal generated by <f₁, f₂, . . . , fₛ> satisfies the properties of ideals. A subset I is called an ideal if:

1) 0 ⊂ I;

2) if f,g ⊂ I then f+g ⊂ I; and

3) if f ⊂ I and h is a rational function in field k of n variables, then hf ⊂ I.

The ideal generated by a finite number of polynomials is a simple example, and also one which allows us to reason about affine varieties. An ideal can be said to be finitely generated, if there exist polynomials <f₁, f₂, . . . , fₛ>ε [x₁, x₂, . . . , xₙ], such that I=<f₁, f₂, . . . , fₛ>. Then, the polynomials f₁, f₂, . . . , fₛ, are called the basis of I. A given ideal may have many bases, and in the next section, we describe a particularly useful basis, the Gröbner basis.

VI. Gröbner Basis

Given an ideal I C k[x], we know that I=<g> for some g ε k[x] (polynomial of single variable in the field k). Given f ε k[x], to check whether f ε I (ideal membership problem), we divide f by g

f=q·g+r

where q, r ε k[x], then f ε I if and only if, r=0. This can be generalized to multiple variables also.

A. Lexical Ordering of Monomials

Given n variables in k[xₙ], we order the variables in the monomial in lexical order such that x₁>x₂> . . . >xₙ. Given a monomial order, we can define multidegree of f, leading coefficient, and leading monomial.

B. Buchberger's Algorithm

Given a division algorithm for polynomials, we can use the greatest common divisor (GCD) algorithm to calculate gcd(f₁, f₂). For a fixed monomial order a finite subset G=g₁, g₂, . . . , gₜ of an ideal I is called a Gröbner basis if and only if the leading term of any element of I is divisible by one of the leading terms of any gᵢ. Consider two polynomials

f₁=x³−2xy (Eq. 11)

f₂=x₂−2y²+x. (Eq. 12)

Using the computer algebra system REDUCE, the Gröbner basis can be calculated using the instructions below in Listing 1:

LISTING 1

load_package groebner;
torder({ },lex);
f1 : = x\hat{ }3 − 2xy;
f2 : = x\hat{ }2 − 2y\hat{ }2 + x;
groebner{f1,f2};
{ x − 2y\hat{ }2, y\hat{ }3 }
torder({ },gradlex);
groebner{f1,f2};
{ x\hat{ }2,xy, 2y\hat{ }2−x }.

Thus the Gröbner basis of polynomials shown in (Eq. 11) and (Eq. 12), using lex order is {x−2y², y³} and using the gradlex order, the Gröbner basis is {x², xy, 2y²−x}. The implementation of Gröbner basis in REDUCE uses Buchberger's algorithm. Since g is a list of polynomials which represents the ideal I, checking f ε I is equivalent to dividing f by g, and checking whether the remainder is zero or not.

VII. Example Method of Using Gröbner Basis

In this section, an exemplary method of using a Gröbner basis to propose solutions to the design and analysis problems of silicon photonics array waveguide is disclosed. The exemplary method can be used for component designers to incorporate our algebraic geometry checks as parameter self-consistency checks. Larger photonic primitives such as WDM, resonators, S-bend connectors, couplers, and tapers, provided in photonic PDKs and libraries, often have about 15-40 parameters. The feasible region, where a combination of these parameters yields a correctly functioning photonic device, is nontrivial to estimate, and computationally expensive to verify by running traditional layout verification software such as DRC. By employing the disclosed method into a PDK component description, a self-consistency check can be developed elegantly.

Another application of the disclosed technology is for top-level analysis of a photonic system that is hierarchically composed of primitive building blocks. Each primitive has with it, an associated algebraic geometry model. The model is consistent with (and dependent on) the parameters of the primitive component. The model can be inspected to yield the bounding-box or minimum rectilinear extent; this is used to perform an efficient filtering of data before QE checks for DRC are performed. In some of the disclosed methods, computational requirements are similar. In some implementations, the method requires a polynomial and rational arithmetic library. Gröbner basis calculations are not needed if the set of allowed parametric functions are fixed; then the Gröbner basis can be precalculated and stored. As the parametric curves are rational, differentiation operators are easy to compute.

A. Construction of Envelopes

Above, we have seen examples of parametric curves, which in theory could be used to form waveguides. But since the waveguides have a finite width, an expansion of the curve using either a circle or square shape is performed. We first consider a basic envelope that is created by moving a circle of radius r=2 on the line y=x. The locus of a circle which moves on this line can be given as

$$\begin{matrix}F = {( x - t )}^{2} + {( y - t )}^{2} - 4 = 0 \\ = 2 {t}^{2} - 2 tx - 2 ty + {x}^{2} + {y}^{2} - 4 = 0.\end{matrix} \qquad ( Eq . 13 )$$

One can calculate

$$\frac{\partial }{\partial t} F = 2 ( 2 t - x - y ) . \qquad ( Eq . 14 )$$

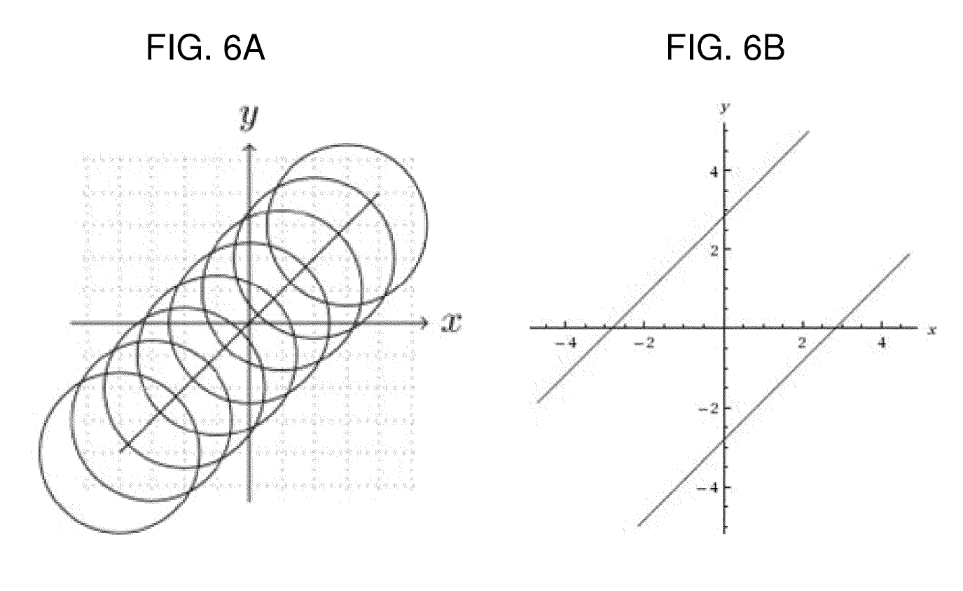

Equation (13) describes the family of circles of radius r=2 in R² whose centers lie on the curve defined by y=x. The parametric curve family is shown in FIG. 6(a). The boundary of this family of curves is simultaneously tangent to all circles in the family. This tangent space is called the envelope of the parametric curve. The envelope is a single curve that is tangent to all the curves in the family, as shown in FIG. 6(b).

Given a polynomial F ε R[x, y, t] the variety in R² defined by F(x, y, t)=0 is denoted V(F₁), and the family of curves determined by F consists of the varieties V(Fₜ) as t varies over R. Thus, given a family V(Fₜ) of curves in R², its envelope consists of all points (x, y)ε R² satisfying

$$F ( x , y , t ) = 0$$

$$\frac{\partial }{\partial t} F ( x , y , t ) = 0.$$

Equation (16) can be thought as the condition for the tangent [defined by f′(t)]. The Gröbner basis can be calculated (e.g., using REDUCE) of F, ∂F to get

{g₁: 2t−x−y, g₂: x²−2xy+y²−8}.

Since g2 is independent of t, it is the elimination ideal, and gives the tangent space.

Next, a slightly more complex example is evaluated. Consider a parametric curve

x=t, y=4t²+3t+8. (Eq. 17)

Next, if we consider the envelope formed by moving a circle in R² on this curve, the following locus equation is produced:

(x−t)²+(y−4t²−3t−8)²=r². (Eq. 18)

Using (15) and (16), for the parametric curve defined in (Eq. 17), the following are produced:

$$F = {( x - t )}^{2} + {( y - 4 {t}^{2} - 3 t - 8 )}^{2} - {r}^{2} = 0$$

$$\frac{\partial }{\partial t} F = - 2 ( x - t ) + 2 ( - 8 t - 3 ) ( y - 4 {t}^{2} - 3 t - 8 ) = 0.$$

To compute the equation of the envelope, the Gröbner basis is used. Using lexicographic order t>x>y, a Gröbner basis for the above system of equations is given by (for a specified r=2)

p1: (y−4t²−3t−8)²+(x−t)²−4

p2: 2(−8t−3)(y−4t²−3t−8)−2(x−t)
poly_reduced_grobner([p1,p2], [t, x, y]);

One of the returned basis gives us the elimination ideal, g₁ which does not depend on t. Since g₂ is independent of t, it is the elimination ideal, and gives the tangent space.

Next, a slightly more complex example is examined. Consider a parametric curve:

x=t, y=4t²+3t+8. (Eq. 17)

Next, if the envelope formed by moving a circle in R² on this curve is considered, the following locus equation is produced:

(x−t)²+(y−4t²−3t−8)²=r². (Eq. 18)

Using (Eq. 15) and (Eq. 16), for the parametric curve defined in (Eq. 17), the following are produced:

$$F = {( x - t )}^{2} + {( y - 4 {t}^{2} - 3 t - 8 )}^{2} - {r}^{2} = 0$$

$$\frac{\partial }{\partial t} F = - 2 ( x - t ) + 2 ( - 8 t - 3 ) ( y - 4 {t}^{2} - 3 t - 8 ) = 0.$$

To compute the equation of the envelope, the Gröbner basis is used. Using lexicographic order t>x>y, a Gröbner basis for the above system of equations is given by (for a specified r=2)

p1: (y−4t²−3t−8)²+(x−t)²−4

p2: 2(−8t−3)(y−4t²−3t−8)−2(x−t)
poly_reduced_grobner([p1,p2], [t, x, y]);

One of the returned basis gives us the elimination ideal, g₁ which does not depend on t.

B. Singularity Detection

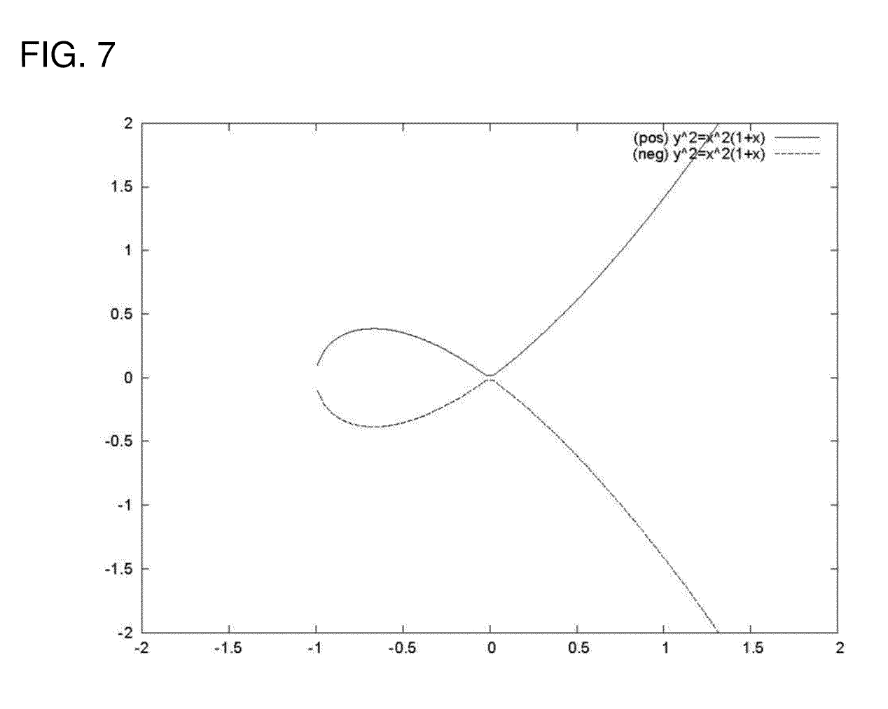

Computational geometry software, especially scanline-based software, is very sensitive to lap-count errors. Lap count is defined on a scanline (assumed to be vertical from y=[−∞: ∞]); as we walk up the scanline, the lap count is increased every time we enter a closed Jordan curve, and decreased when we exit it. By definition, the lap count starts at zero and for a well-ordered scanline, will exit at zero count as well. When a shape is self-intersecting, the lap count has to be carefully modified using the winding number, a concept introduced to computational geometry from complex analysis. For self-intersecting curves, points of singularity, where lap counts have to be corrected explicitly, can be defined as discussed below. Consider the curve y²=x²(1+x) shown in FIG. 7. We define the singularity point as the point on the curve V(f) such that the tangent line fails to exist. Calculating singularity is done by intersecting V(f) by a line L and calculating the gradient ∇f.

The singular points off can be determined by solving the equations

$$f = \frac{\partial }{\partial x} f = \frac{\partial }{\partial y} f = 0.$$

For the curve y²=x²(1+x) shown in FIG. 7, we get

$$\begin{matrix}f \text{:} {y}^{2} = {x}^{2} ( 1 + x ) & ( 19 ) \\ \frac{\partial }{\partial x} f = - 2 x - 3 {x}^{2} = 0 & ( 20 ) \\ \frac{\partial }{\partial y} f = 2 y = 0. & ( 21 )\end{matrix}$$

Equations (19)-(21) can be solved using Gröbner basis methods and we see that the point (0, 0) is the only point of singularity of this curve. This method is generally applicable to algebraic curves, and thus can be used for array waveguide curves as well.

C. Manufacturability Checks

Consider two curves C₁ and C₂. Let us assume that C₁ and C₂ are parametric curves of the envelopes of waveguides and a check to determine if the minimum Euclidean distance between any two points on each curve is smaller than a manufacturable limit. Using mathematical notation this check can be expressed as

∃(x₁, y₁)ε C₁, (x₂, y₂)ε C₂:(x₁−x₂)²+(y₁−y₂)²<D²

where D² represents the square of the constraint. Such existence queries can be efficiently solved using the method of QE.

The envelope C₁(C₂) of C₁(C₂) is created with a circle of radius D. Given parametric representation of C₁ as f₁ₓ(t₁), f_{1y}(t₁) with t₁:[q₁₁:q₁₂] and similarly for C₂f₂ₓ(t₂), f_{2y}(t₂) with t₂:[q₂₁:q₂₂], the minimum spacing check can be written as a sentence:

(∃t)(∃x)(∃y)st

:q₁₁≦t≦q₁₂

:q₂₁≦t≦q₂₂

:x=f₁ₓ(t)=f₂ₓ(t)

:y=f_{1y}(t)=f_{2y}(t),

These formulas can be entered into QEPCAD as prenex formulas. A partial CAD of the configuration space is created, and proves whether a solution can exist in each of the cells or not. Consider the sentence (∃x)(∃y)F(x, y). The key idea of using partial CAD is based on the observation that a decomposition D₁ of R¹ can be lifted to R² by constructing a stack of cells in the cylinder over each cell of D₁. Each cell has a TRUE or FALSE value depending on F. Rather than construct all cells of D₁, each cell is constructed in sequence and the method aborts the CAD as soon as (∃x)(∃y)F(x, y) becomes TRUE. Using QE for manufacturability checks can be used with rational parametric curves to design photonic waveguides.

Even if the parameterized curves C′₁ and C′₂ are not available readily, CAD can be used as follows:

(∃t₁)(∃t₂)(∃x)(∃y)st

:q₁₁≦t₁≦q₁₂

:q₂₁≦t₂≦q₂₂

:(f₁ₓ(t₁)−f₂ₓ(t₂))²+(f_{1y}(t₁)−f_{2y}(t₂))²<D².

Primary curves are used with t₁ and t₂ parameters and the Euclidean distance between the curves is checked. Using C₁ and C₂ increases the number of variables in the algebraic decomposition by a factor of two, and moreover, these curves cannot be used to check minimum width, enclosure, MRC, and grid snapping (resolution) checks.

D. Bias Application

In many examples, lithographic correction is applied to isolated lines in the form of applied bias. For rectilinear polygons, application of bias (both positive and negative), is relatively straightforward, but even for PWL polygons with all-angle edges, the behavior of biasing for acute angles is carefully monitored, lest the output polygon become self-intersecting. When dealing with curvilinear shapes such as waveguides, this problem is exaggerated. In such cases, the application of good local behavior of an offset to an algebraic curve can be used. Such techniques are based on the equality of the topology of the biased curve to the original curve. However, the degree of the resulting polynomial of the offset has high degree, as compared to the original curve. In some examples, a trimmed offset is used, where certain branches of the biased shape are discarded. Such closed form expressions of the offset can be very useful when retargeting the waveguides curves from one technology node to another. A table of such functions that can be built using Gröbner basis methods is described above.

### VIII. Example Implementation and Corresponding Experimental Data

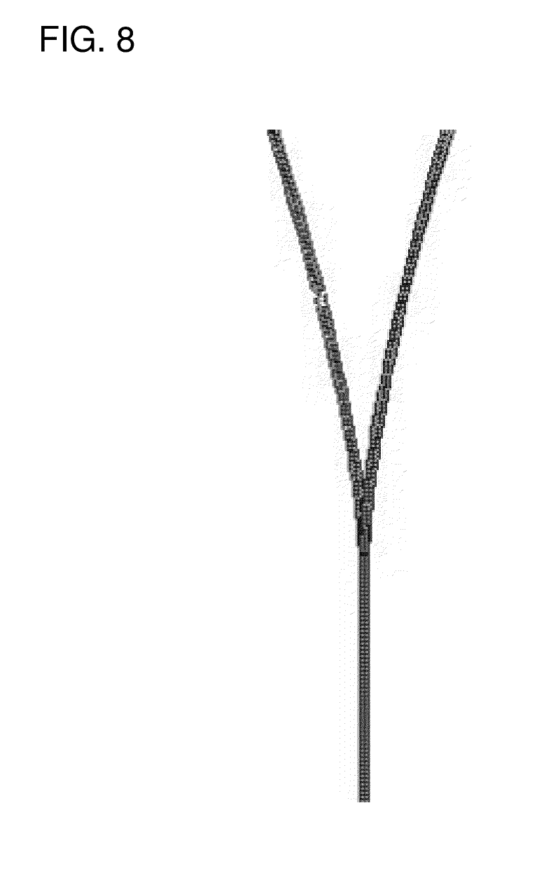

We have performed experiments with the Gröbner basis methods presented in this paper, and implemented a parametric curve processing system which accepts control file input in the form shown below in Listing 2. A corresponding generated mask layout is shown in FIG. 8.

LISTING 2

# comment: this is a Y-junction example
begin design Y-junction
G left_branch −105 0 100 40 49
P x = 3 0.5 −1 1 0 P
y = 2 100 10 0
endg
G right_branch 0 105 100 40 49
P x = 3 0.5 −1 1 0 P
y = 2 100 10 0
endg
G line0 −1000 0 10 42 49
P x = 1 0 0
P y = 1 1000 1000
endg
I left_branch 0 0 0
I right_branch 0 0 0
I line0 0 0 0
end design.

In the above Listing 2, G denotes a group identifier, which in turn can be comprised of primitive shapes such as trapezoids (subsumes rectangles and squares), and rational parametric curves of paired polynomials in x and y. Every group has exactly one paired polynomial. The syntax of the polynomial statement is P x=(or P y=), followed by the degree of the polynomial and a list of coefficients. The syntax of the group statement is G, name, starting range of the parameter, ending range, sampling frequency, envelope radius and curve mask layer. A group construct is terminated with endg. Groups can be instantiated with the I construct, which refers to the group name, rotation angle, and the x- and y-translation. Given these curves: the envelopes, singularities and spacing checks can be performed as discussed above. For example, Bezier curves can be represented as shown in Listing 3:

LISTING 3

G curve0 0 1 10 40 49
B 0 0 0 10 10 10 10 0
endg.

This defines the control points as (0, 0), (0, 10), (10, 10), and (10, 0). Internally the system constructs the parametric curve and uses that for computation. Specifically, calculation of bias on this representation is calculated by the program as

B′=bias(B, d)

where B is the group representation of a Bezier curve. The disclosed system converts B to a parametric curve and computes new control points for the biased curve B′. This is done without conversion to vector or raster format.

A. Dimensional Checks Using QE

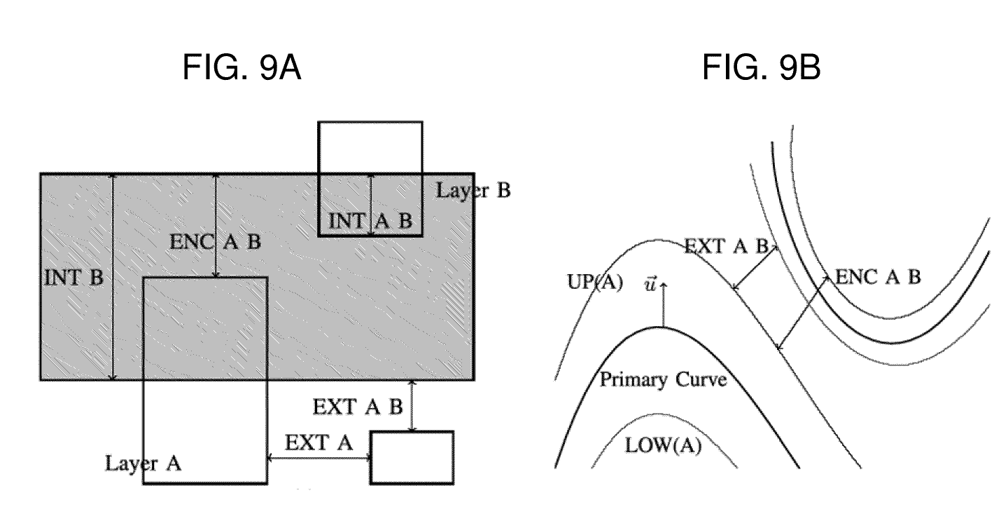

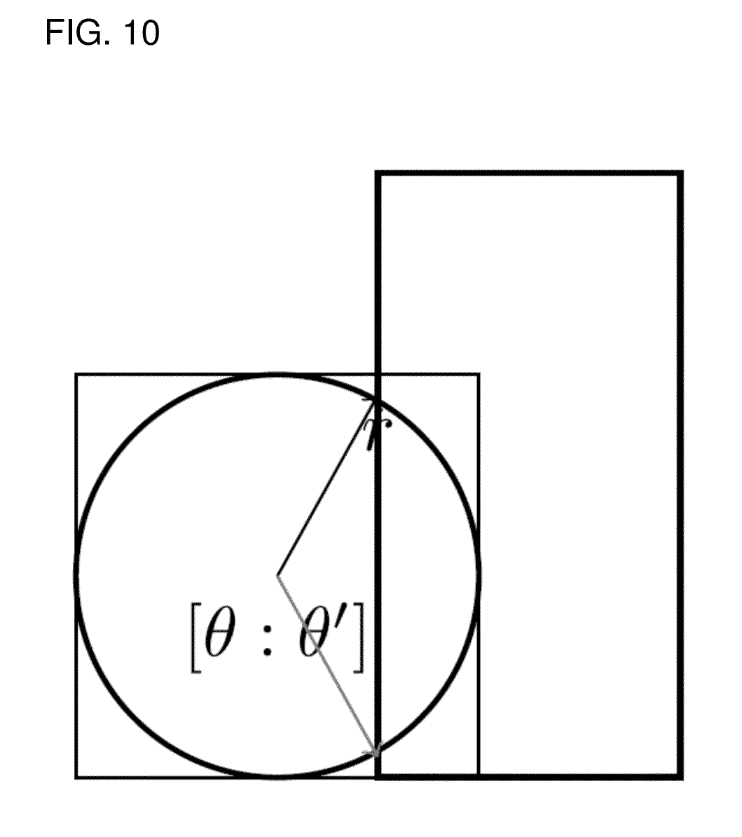

Dimensional checks can be used to verify that spacing constraints of the process rule deck are not violated in the design. Commonly used dimensional checks include: EXTERNAL, INTERNAL, and ENCLOSURE. Examples of these checks are shown in FIG. 9(a) for rectilinear shapes. The direction of the edges can be calculated using vector geometry. The notation \vec{u} is used to denote a unit normal vector. For minimum width, spacing, and enclosure checks, the role of DRC is to verify that no correctly facing edges in the layout are closer (using the Euclidean distance) than the specified rule distance. For an edge to be closer than Wₓ there must exist points (x₁, y₁) on the first envelope and (x₂, y₂) on the second envelope whose Euclidean distance is smaller than Wₓ. For parametric curves, the edge facing relations are calculated, as shown in FIG. 9(b) and listed in Table I. The directions of the normals for the curves A and B can be used in deciding if the curves are facing in a valid direction for the check.

### Dimensional Check Operators Using Envelopes

TABLE I

| Rule | Layer | Envelope | Normal (\vec{u}, \vec{v}) |
|---|---|---|---|
| EXTERNAL | A A | UP(A) LOW(A) | EXT(A) EXT(A) |
| EXTERNAL | A B | UP(A) LOW(B) | EXT(A) EXT(B) |
| | | LOW(A) UP(B) | EXT(A) EXT(B) |
| INTERNAL | A A | UP(A) LOW(A) | INT(A) INT(A) |
| INTERNAL | A B | UP(A) LOW(B) | INT(A) INT(B) |
| | | LOW(A) UP(B) | INT(A) INT(B) |
| ENCLOSURE | A B | UP(A) UP(B) | EXT(A) INT(B) |
| | | LOW(A) LOW(B) | EXT(A) INT(B) |

The upper envelope always lies above the primary curve (by definition), and thus spacing checks (for example) can be calculated as a constraint on the distance between the upper envelope of curve A [denoted UP(A)] and the lower envelope of curve B [denoted LOW(B)]. The curves A and B may be present on different layers, and it should be noted that the ENCLOSURE operator is noncommutative, as it measures the external facing contour of A with the inner facing contour of B. In FIG. 9(b) the primary curve, as well as the upper and lower envelopes, are shown, as well as the contour pairs that are analyzed by the disclosed methods.

It should be noted that modern layout verification rule decks have tens of thousands of operations, and the above-mentioned dimensional check operators are only a very small part of a set of typical layout verification tasks. Thus, the disclosed methods are not necessarily a substitute for running full chip DRC, but can be used to generate automatic DRC waivers to reduce false errors.

In some examples, QE is used to detect minimum width errors on a waveguide curve as shown below. The governing equations of the upper and lower curve forming the adiabatic taper are:

y₁=10x₁²+8x₁+80

y₂=x₂³−2x₂.

The minimum width condition can be written as

(x₁−x₂)²+(y₁−y₂)²>r²

where r is the constraint and r² ε [400:500]: we can use QEPCAD to answer this existence problem as shown in Listing 4:

LISTING 4

Enter a variable list: (r2,x1,x2)
Enter the number of free variables: 2
Enter a prenex formula:
(Ex2)[(x1−x2) \hat{ }2 + (10x1\hat{ }2+ 8x1 + 80 − x2\hat{ }3−2x2)\hat{ }2 < r2].
Before Normalization >
assume [ x1 > = −10 /\ x1 < = 0
/\ r2 > = 400 /\ r2 < = 500 ]
Before Normalization > finish An equivalent quantifier-free
formula:
40 x1\hat{ }3 + 48 x1\hat{ }2 − 3587 x1 − 1442 > 0 \/
120 x1\hat{ }2 + 96 x1 − 3587 < 0 \/
100 x1\hat{ }4 + 160 x1\hat{ }3 − 17935 x1\hat{ }2 − 14420 x1 − r2 + 810100 <
0.

Solving this with QE, a closed form formula describing the exact condition is obtained, where there will be a minimum width error. Moreover, for some values of r the system can prove that there cannot be an error, which can be useful for self-consistency check of parameters in PDK components. See Listing 5:

LISTING 5

assume [ r2 < 10 ]
An equivalent quantifier-free formula:
FALSE.

B. Layout Verification Methodology

Having disclosed the building blocks of certain exemplary methods, and example layout verification methodology based on algebraic geometry is further detailed below.

1) Input: Schematic capture of the design in a hierarchical manner, library of primitives (such as rings, S-bends, tapers) in algebraic form of parametric polynomials, technology specification (minimum width rules, etc).

2) Output: Either a certificate of DRC clean data or error markers. The algorithm is the sequence of following operations.

1) Load Design: The schematic file is parsed and individual components (such as rings, S-bends, couplings, tapers) are loaded into memory. Associated parameters (such as ring radius, taper slopes), along with connectivity and physical placement are also stored in an instance data structure. The root cell of this hierarchical directed acyclic graph is calculated.

2) Evaluate Parameters: Each component's parameters are evaluated in reverse topological order (from bottom of the hierarchical tree leaves to the root). Parameters are checked for self-consistency using component rules, and the rectilinear bounding box for each instance is computed.

3) Create BBox Grid: The bounding box for each instance is placed in a spatial data structure which supports range queries. Thus, given any instance, all other instances whose bounding box intersect with it (or with any arbitrary box) can be calculated in O(log(n)+k) time, where n is the number of instances and k is the number of intersections reported. After the grid is constructed, a pairwise interaction callback function is called for every pair of intersecting boxes. To check DRC, the boxes are oversized by half the rule check dimension. The callback is of the form: intersectionCallback(E₁, E₂, BBOX1, BBOX2).

4) Recursively Expand Hierarchical Shapes: In the callback, E₁ is inspected to see if it is a hierarchical instance, if so, it is expanded and we recursively call the callback function. Similarly, E₂ is inspected. However, the order of E₁ and E₂ is not transposed, so as to enable noncommutative checks such as ENCLOSURE.

5) Perform Callback With BBox Intersection: Once it is known that E₁ and E₂ are flat, a algebraic geometry representation can be used as follows. Since E₁ is a parametric polynomial in t₁ (similarly E₂ is a function in t₂), the range [t₁: t′₁] and [t₂: t′²] can be calculated which interact with the bounding boxes.

In some examples, The callback function is the majority of the computation (and can be executed in parallel threads).

1) P1: getPolynomial(E₁, BBOX1): Get polynomial from component; modify it based on BBOX1.

2) P2: getPolynomial(E₂, BBOX2): Get polynomial from component; modify it based on BBOX2.

3) ApplyCheck[rule, ̂(BBOXI, BBOX2)]: Calculate bounding box intersection based on rule distance.

4) ApplyCheck(rule, P1, [t₁: t′₁], P2, [t₂: t′₂]): Calculate polynomial parameter ranges which interact in the bounding box intersection.

5) QE=ConvertToPrenex(rule, P1, [t₁: t′₁], P2, [t₂: t′₂]: Generate the QE equations to check the rule. For all components in the library, prenex conversions are precomputed and can be looked up.

6) RunQuantifierElimination(QE)

7) ReturnResult: If the result of the QE is NULL, then we have no errors, otherwise output from P1[t₁: t′₁] and P2[t₂: t′₂] is generated as error marker.

The above algorithm includes the inverse computation of the polynomial parameter range (t₁: t′₁) of P1 from the bounding box intersection of BBOX1 and BBOX2. As shown in FIG. 10, for primitive components in the library, the polynomial parameter range which causes the component to intersect a given bounding box is dynamically cached. In FIG. 10, the ring is intersecting an overlapping bounding box. Using a trigonometric parameterization, the angle ranges for the ring interacting with the bounding box intersection, can be computed and cached.

The algorithmic complexity of the proposed method is O(kN), where k is the expected number of interactions between the bounding boxes, and N is dependent on the maximum degree of the parametric curves (which is usually less than 16). The proposed method was implemented in the C++ programming language using a polynomial arithmetic library.

C. Example Method

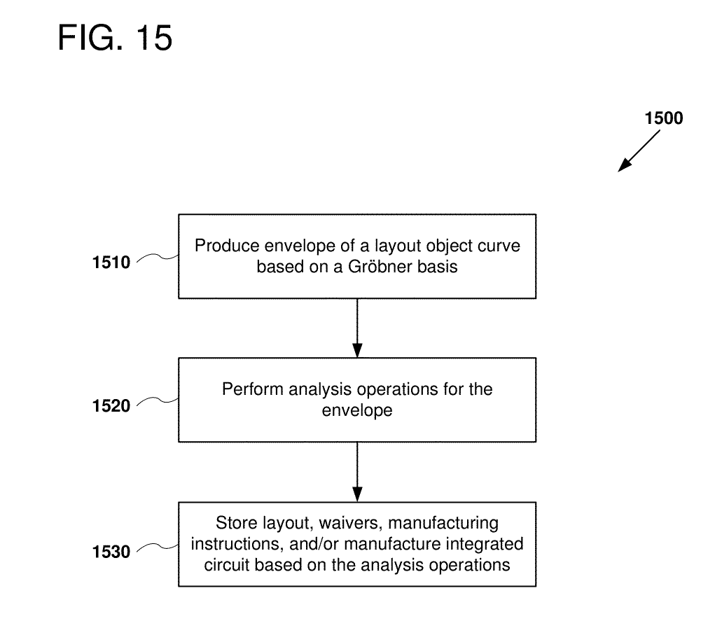

FIG. 15 is a flow chart 1500 outlining an example method of performing analysis operations for an envelope of a layout object curve, as can be performed in certain examples of the disclosed technology.

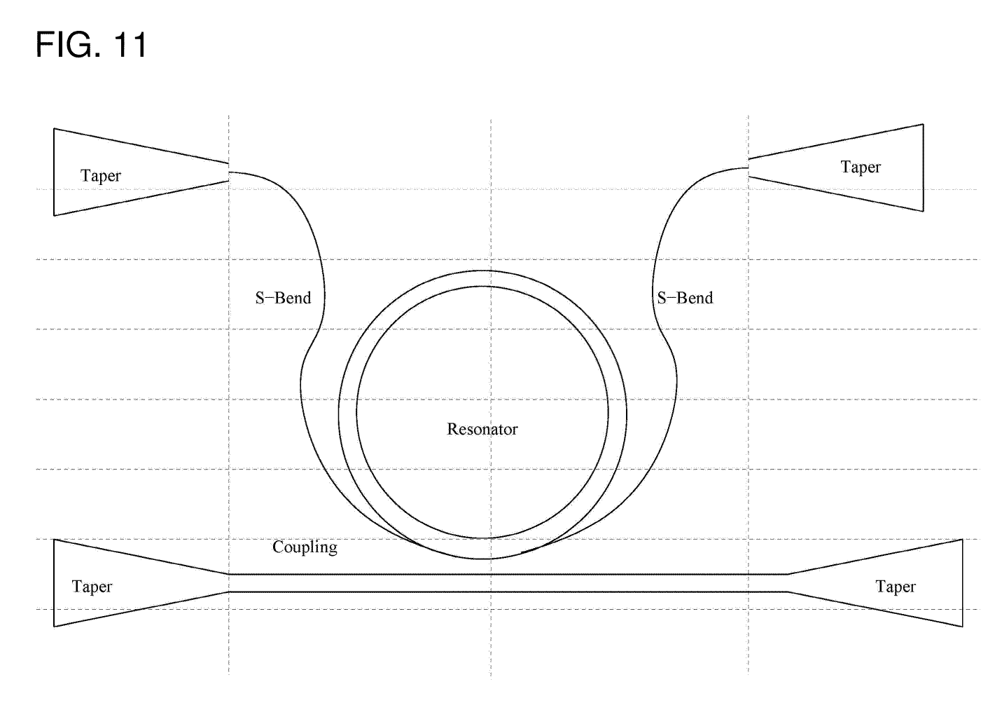

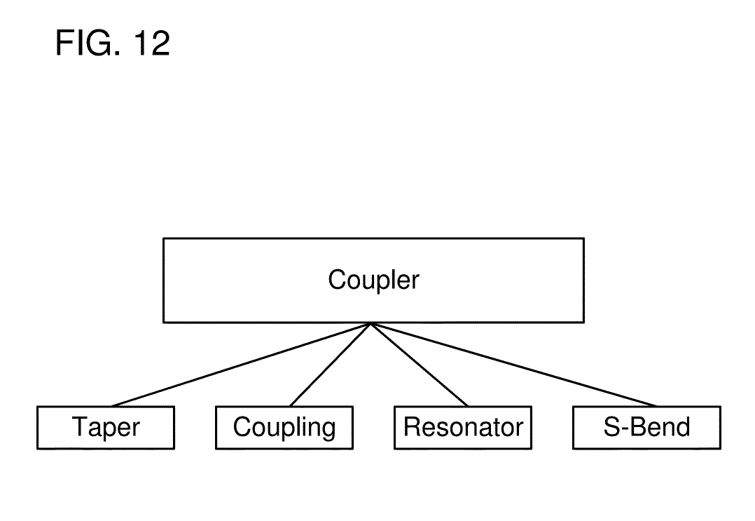

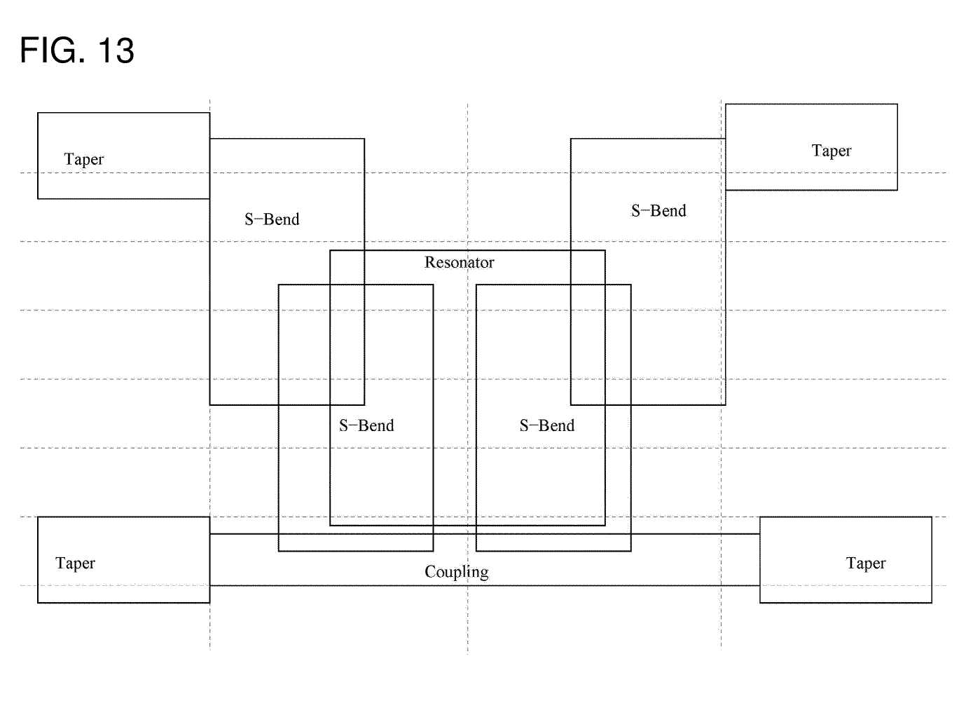

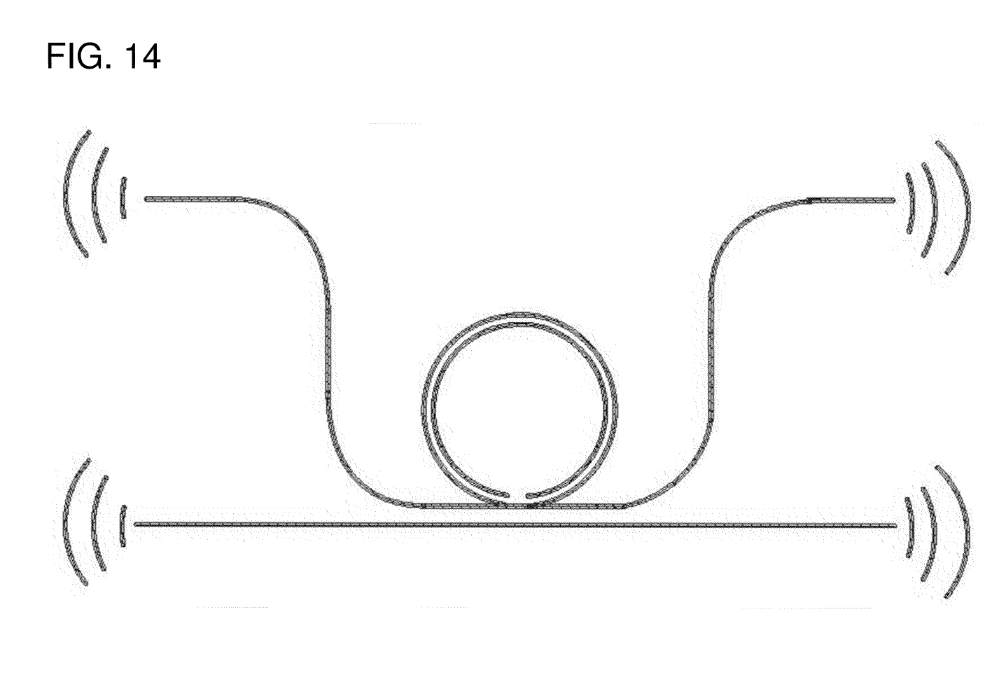

At process block 1510, an envelope is produced for one or more layout object curves based on computing a Gröbner bases for the curves. For example, consider the schematic of the photonic coupler circuit shown in FIG. 11. A hierarchy tree of the design is shown in FIG. 12. The number of individual instances of each component are not marked in the figure, but are used in the implementation. After parameter checking, the component is evaluated for its rectilinear extent and the resulting collection of bounding boxes are stored in a spatial data structure as shown in FIG. 13. Once the envelope is produced, the method proceeds to process block 1520.

At process block 1520, analysis operations are performed for the envelope(s) produced at process block 1510. For example, using this grid and the above-described algorithm, QE is called on the pairwise interactions between the taper, S-bend, resonator and coupling primitives. The polynomial equation for the taper is x=t, y=C+w(t), where w(t) is an auxiliary function denoting the slope (width) of the taper. The S-bends are polynomials of degree 5. The complete list of primitive components and their parameters is given in Table II. After performing the analysis operations, the method proceeds to process block 1530.

### Photonic Components and Parameters

TABLE II

| Component | Parameter | Parametric Equation |
|---|---|---|
| Rectangle | width, centerline | x = t, y = y₀ + w/2 |
| Ring | x, y, r₀, r₁ | x = r₀ cos(t) |
| | — | y = r₀ sin(t) |
| S-Bend [34] | x₁, y₁, x₂, y₂ | x = Wt |
| | W, V | y = Vt³(6t² − 15t + 10) |
| Linear Taper | x₁, y₁₁, y₁₂ | ${m}_{1} = \frac{{y}_{21} - {y}_{11}}{{x}_{2} - {x}_{1}} , ( t , {m}_{1} t + {y}_{11} )$ |
| | x₂, y₂₁, y₂₂ | ${m}_{2} = \frac{{y}_{22} - {y}_{12}}{{x}_{2} - {x}_{1}} , ( t , {m}_{2} t + {y}_{21} )$ |
| Confocal Taper | n, r₁, r₂, d, θ₁, θ₂ | [10] |

At process block 1530, the layout can be certified as DRC clean or a number of errors and/or warning for the layout indicated. The layout (or modified layout, once the errors and/or warnings have been addressed) can be stored in a computer-readable storage medium as, for example, a GDSII or OASIS file. In some examples, a mask writer file including instructions for a mask writer or other reticle manufacturing tools is stored in a computer-readable storage medium. In some examples, an integrated circuit is manufactured based at least in part on a layout and/or mask writer file generated at process block 1530.

An example of the generated mask layout for the coupler is shown in FIG. 14. The complete processing time for running the parameter self-consistency check, minimum width check, spacing check, as well as the mask layout was less than a few minutes. In this particular example, the generated mask layout DRC showed an error, which upon inspection, turned out to be a false error due to grid snapping.

### IX. Example Computing Environment

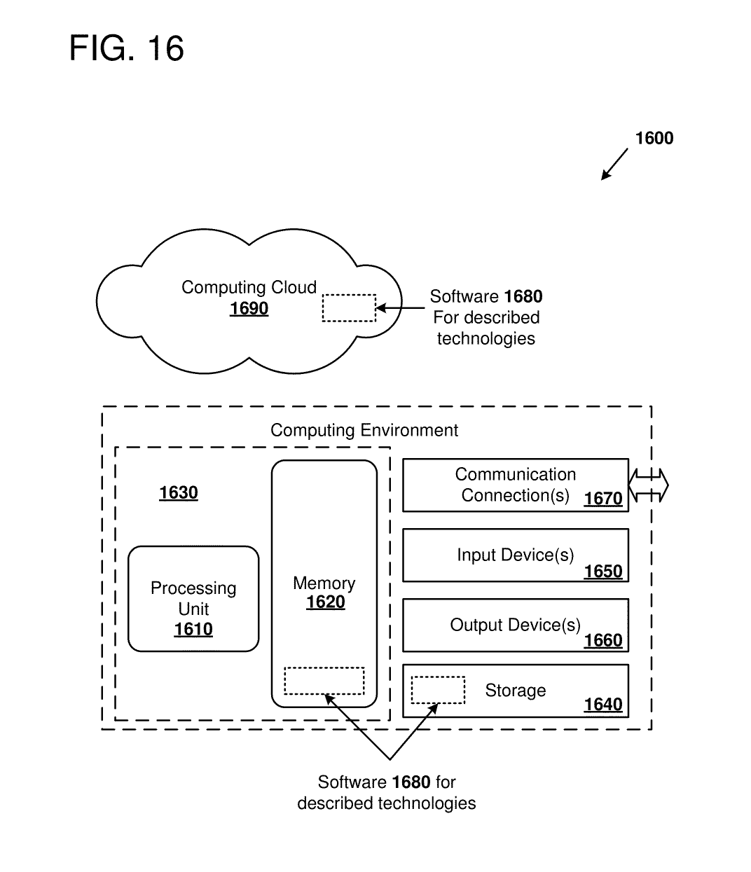

FIG. 16 illustrates a generalized example of a suitable computing environment 1600 in which described embodiments, techniques, and technologies, including producing an envelope of a curve based at least in part on a Gröbner basis and performing one or more analysis operations for the envelope, can be implemented. For example, the computing environment 1600 can implement any of the analysis operations, as described herein.

The computing environment 1600 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 16, the computing environment 1600 includes at least one central processing unit 1610 and memory 1620. In FIG. 16, this most basic configuration 1630 is included within a dashed line. The central processing unit 1610 executes computer-executable instructions and may be a real or a virtual processor. In a multi-processing system, multiple processing units execute computer-executable instructions to increase processing power and as such, multiple processors can be running simultaneously. The memory 1620 may be volatile memory (e.g., registers, cache, RAM), non-volatile memory (e.g., ROM, EEPROM, flash memory, etc.), or some combination of the two. The memory 1620 stores software 1680, images, and video that can, for example, implement the technologies described herein. A computing environment may have additional features. For example, the computing environment 1600 includes storage 1640, one or more input devices 1650, one or more output devices 1660, and one or more communication connections 1670. An interconnection mechanism (not shown) such as a bus, a controller, or a network, interconnects the components of the computing environment 1600. Typically, operating system software (not shown) provides an operating environment for other software executing in the computing environment 1600, and coordinates activities of the components of the computing environment 1600.

The storage 1640 may be removable or non-removable, and includes magnetic disks, magnetic tapes or cassettes, CD-ROMs, CD-RWs, DVDs, or any other medium which can be used to store information and that can be accessed within the computing environment 1600. The storage 1640 stores instructions for the software 1680, plugin data, and messages, which can be used to implement technologies described herein.

The input device(s) 1650 may be a touch input device, such as a keyboard, keypad, mouse, touch screen display, pen, or trackball, a voice input device, a scanning device, or another device, that provides input to the computing environment 1600. For audio, the input device(s) 1650 may be a sound card or similar device that accepts audio input in analog or digital form, or a CD-ROM reader that provides audio samples to the computing environment 1600. The output device(s) 1660 may be a display, printer, speaker, CD-writer, or another device that provides output from the computing environment 1600.

The communication connection(s) 1670 enable communication over a communication medium (e.g., a connecting network) to another computing entity. The communication medium conveys information such as computer-executable instructions, compressed graphics information, video, or other data in a modulated data signal. The communication connection(s) 1670 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed computer-executable instructions. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1690. For example, layout design operations can be performed in the computing environment while analysis operations can be performed on servers located in the computing cloud 1690. In some examples, the servers in the computing cloud 1690 are located in a different country or jurisdiction than the computing environment.

Computer-readable media are any available media that can be accessed within a computing environment 1600. By way of example, and not limitation, with the computing environment 1600, computer-readable media include memory 1620 and/or storage 1640. As should be readily understood, the term computer-readable storage media includes the media for data storage such as memory 1620 and storage 1640, and not transmission media such as modulated data signals.

In view of the many possible embodiments to which the principles of the disclosed subject matter may be applied, it should be recognized that the illustrated embodiments are only preferred examples and should not be taken as limiting the scope of the scope of the claims to those preferred examples. Rather, the scope of the claimed subject matter is defined by the following claims. We therefore claim as our invention all that comes within the scope of these claims and their equivalents.

We claim:

1. A method of analyzing a layout to be manufactured using a photolithographic process, the method comprising:
producing an envelope of a curve based at least in part on a Gröbner basis, the curve representing an object in the layout; and
performing one or more analysis operations for the envelope.

2. The method of claim 1, wherein the analysis operations comprise at least one or more of the following verification checks: a dimensional check, a spacing check, a width check, and/or an enclosure check.

3. The method of claim 1, wherein the analysis operations comprise at least one or more of the following operations: singularity detection, manufacturability checking, and/or bias application.

4. The method of claim 1, wherein the analysis operations comprise dimensional checks using quantifier elimination.

5. The method of claim 1, wherein the analysis operations comprise filtering data representing the layout using rectilinear bounding boxes representing the extent of a plurality of objects in the layout.

6. The method of claim 1, wherein the curve is represented using a system of one or more equations.

7. The method of claim 1, wherein the layout object comprises optical interconnect.

8. The method of claim 1, wherein the layout comprises one or more silicon photonic devices.

9. The method of claim 1, wherein the layout comprises curves for a micro-electronic mechanical system (MEMS) and/or a micro-fluidics VLSI layout.

10. The method of claim 1, wherein the curve is a parametric curve or a Bezier curve.

11. The method of claim 1, wherein the envelope is produced based at least in part using Buchberger's algorithm.

12. The method of claim 1, further comprising, based on the performing the analysis operations, storing the layout in a computer readable storage medium.

13. The method of claim 1, further comprising, based on the performing the analysis operations, generating a file comprising instructions for a mask or reticle manufacturing tool.

14. The method of claim 1, further comprising, based on the performing the analysis operations, manufacturing an integrated circuit.

15. The method of claim 1, further comprising, based on the performing the analysis operations, generating one or more waivers for a design rule or manufacturability check.

16. The method of claim 1, further comprising, based on the performing the analysis operations, modifying the layout object.

17. One or more computer readable storage media storing computer-readable instructions that when executed by a computer, cause the computer to perform the method of claim 1.

18. A system comprising:
one or more processors;
memory; and
one or more computer readable storage media storing computer-readable instructions that when executed by a computer, cause the computer to perform the method of claim 1.

19. All new and nonobvious aspects of the disclosed technology performed as method acts both alone and in combinations and subcombinations with one another or implemented as apparatus to perform the method acts both alone or in combinations and subcombinations with one another.

20. An apparatus, comprising any one or more of the novel and nonobvious combinations of features disclosed herein for analyzing layout using algebraic geometry.
